(19) United States
(12) Patent Application Publication
(10) Pub. No.: US 2005/0243716 A1
(43) Pub. Date: Nov. 3, 2005

(54) Systems and methods implementing 1‘and N:1 line card redundancy

(76) Inventors: Nabil N. Bitar, Winchester, MA (US); Thomas A. Hoch, Boxborough, MA (US)

Correspondence Address: JONES DAY, 222 EAST 41ST ST, NEW YORK, NY, 10017, US

(21) Appl. No.: 10/838,781

(22) Filed: May 3, 2004

(51) Int. Cl. H04L 1/00

(52) U.S. Cl. 370/218

(57) ABSTRACT

The present invention provides switching and routing systems and methods useful in packet switching communication networks that efficiently reroute packet traffic through a switch or router upon failure of a line card. According to the invention, every line card on the switch is designated as either primary or protection, and has a redundancy table stored locally that is indexed by the slot ID holding a primary line card, and includes an indicator of whether 1+1 redundancy is configured, an indicator of whether N:1 redundancy is enabled, and a slot ID holding the corresponding protection line card. Each ingress line card consults its locally stored redundancy data in order to correctly forward packets across a switch fabric to proper egress line cards in cases of normal operations and in cases of line card failure.

This application incorporates by reference in their entireties and for all purposes the following patent applications, all of which are owned or subject to a right of assignment to the assignee of the present application and all of which were filed concurrently together with the present application: (1) the application titled “METHODS AND SYSTEMS FOR EFFICIENT MULTICAST ACROSS A MESH BACKPLANE”, by Bitar et al. and identified by attorney docket no. BITAR 7-11-1 (Ser. no. ______) (hereafter, the “Multicast application”); (2) the application titled “VARIABLE PACKET-SIZE BACKPLANES FOR SWITCHING AND ROUTING SYSTEMS”, by Bitar et al. and identified by attorney docket no. BITAR 5-9-3 (Ser. no. ______) (hereafter, the “Variably-sized FDU application”); (3) the application titled “A UNIFIED SCHEDULING AND QUEUEING ARCHITECTURE FOR A MULTISERVICE SWITCH”, by Bitar et al. and identified by attorney docket no. BITAR 4-8-2 (Ser. no. ______) (hereafter, the “Scheduler application”); and (4) the application titled “SYSTEMS AND METHODS FOR SMOOTH AND EFFICIENT ROUNG-ROBIN SCHEDULING”, by Bitar et al. and identified by attorney docket no. BITAR 8-4 (Ser. no. ______) (hereafter, the “SEWDRR application”).

### FIELD OF INVENTION

The present invention relates to communication network equipment (NE), and more particularly to packet switching and routing devices used in communication networks that provide support for 1+1 and N:1 line-card redundancy in the data path across a switch/router backplane. The focus of the present invention is minimizing data loss in the presence of a line card failure.

### BACKGROUND OF INVENTION

A desirable characteristic of a data network is resiliency. A line card is part of a switch/router which is used to receive and process data units from other devices and to forward the data units to other devices. The card in the system may not have external line connections to other network elements (NE) but still connects to other cards within the same system via a switching fabric. The invention presented in this case cover both card types. Ordinarily, when a line card fails, the data units, which would otherwise traverse it, are lost, until a dynamic routing protocol reconfigures the switch/router to forward the data units on the other line cards. This reconfiguration may take several seconds or even minutes.

Alternatively, modern switches/routers provide line card redundancy. A device implementing line card redundancy has primary line cards and protection line cards. A line card is an active line card when it sends and receives data units. When there is no failure, the primary card is ordinarily active, but when the primary card fails, the protection card becomes active.

There are two types of line card redundancy: 1+1 and N:1. 1+1 line card redundancy refers to a configuration where for each protected primary card there is a dedicated protection card. N:1 line card redundancy refers to a configuration where there is a single protection card for N protected primary cards. 1+1 redundancy allows for a primary card to fail over (where “failing over” means that the protection card is sending and receiving the data units destined for the failed primary card). N:1 redundancy allows for only a single card out of N protected cards to fail over, because after the first failure, the protection card will no longer be available as a backup for the remaining N−1 cards.

Previously proposed implementations of 1+1 redundancy and N:1 redundancy took considerable time for the NE to enable the flow of data units through a protection line card, when a primary line card which it was protecting would fail.

### SUMMARY OF THE INVENTION

The present invention includes systems and methods which facilitate efficient switchover from a primary line card to a protection line card in case of primary line card failure. When a failure of a line card is detected, alarms will be generated and consolidated, and the failed line card is identified by the switch/router. Once the failed line card is identified, the protection card for this primary card will become active. In case the failed card was not active, no action related to redundancy will be taken.

The efficiency is facilitated by maintaining information describing the redundancy pairings. For 1+1 redundancy the invention sends every data unit to both the primary and the protection line cards; for N:1 redundancy, it is first necessary to enable the switchover before the data units are sent to the protection card. In this case, every data unit is sent to either the primary or the protection line card, but not to both.

In certain embodiments of the invention this information is stored as a redundancy table on every line card. This table is indexed by the IDs of the slots which hold primary line cards, and for every such slot includes the ID of the slot holding the corresponding protection card, a 1+1 redundancy indicator, and a N:1 redundancy indicator.

In certain embodiments, the 1+1 redundancy requirement for sending two replicas of the same data unit to two different line cards is met by using multicast functionality. In the preferred embodiment, for the switch/router with mesh switch fabric, the replication occurs at the level of the switch fabric hardware by writing the two replicas on two links of the mesh.

In certain embodiments, it may be preferred for the redundancy to be revertive, that is to automatically return to the initial state once the failure on the primary card is cured. In other embodiments, it may be preferred for the redundancy scheme to be non-revertive, that is remaining in the state where the protection card is active even though the failure on the primary card was cured.

### BRIEF DESCRIPTION OF THE DRAWINGS

The present invention may be understood more fully by reference to the following detailed description of the preferred embodiments of the present invention, illustrative examples of specific embodiments of the invention, and the appended figures in which:

FIG. 1 illustrates a line card functionality;

FIG. 2 illustrates 1+1 redundancy;

FIG. 3 illustrates N:1 redundancy;

FIG. 4 illustrates a redundancy table stored in the memory of a line card; and

FIG. 5 illustrates the process of forwarding data units.

### DETAILED DESCRIPTION OF THE PREFERRED EMBODIMENTS

An exemplary switch/router comprises a chassis with slots and a switch fabric. The switch fabric has a number of uniquely addressable interfaces, single interface corresponding to each slot. In some implementations of the switch/router multiple slots can be sharing the same fabric thread. In that case additional systems and methods are required to property identify the exact slot for which data units are destined for on a given thread. This invention does allow this capability by properly identifying a slot and the associated fabric thread. In the preferred embodiment, it is assumed that there is one to one correspondence between a slot and a fabric thread without lack of generality. When a line card is inserted in a slot, it connects to the switch fabric through one of these uniquely addressable interfaces. One line card is then able to forward data units to another line card by forwarding the data units to the appropriate switch fabric interface. Every physical slot on the chassis corresponds to one addressable switch fabric interface. These addressable interfaces are referred to as slot IDs when there is one to one correspondence between a fabric thread and a slot.

Line cards designed to receive and to send traffic on various media are inserted into the slots and connect to the switch fabric. The line cards may have network ports, which are also uniquely identifiable among the ports of the given line card. When these ports exist, the connection between the network ports and the line card can happen in many ways. In the preferred embodiment, this connection is implemented over a cross connect that connects by software configuration ports to a line card. The ports can be logical media channels (e.g., STS1) or physical ports. Alternatively, the method of implementing the connection between the physical ports and the line card may be implemented on a line card hardware. Every port in the switch can be uniquely identified by the slot ID, into which the line card was inserted, and the IID of the port on the line card.

A line card comprises both an ingress component and an egress component. The ingress component comprises an interface to the switch fabric for transmission of the data units to other line cards and one or more input ports on which data units are received from the other network elements (NE), depending on whether the card has network ports or not. The egress component comprises the interface to the switch fabric for receiving the data units from other line cards of the switch, and output ports for transmitting the data unit to the other NEs, depending on whether the card has network ports or not. In the preferred embodiment, both ingress and egress components are part of a single line card. However, in certain embodiments, the ingress and the egress components may be parts of separate physical line cards.

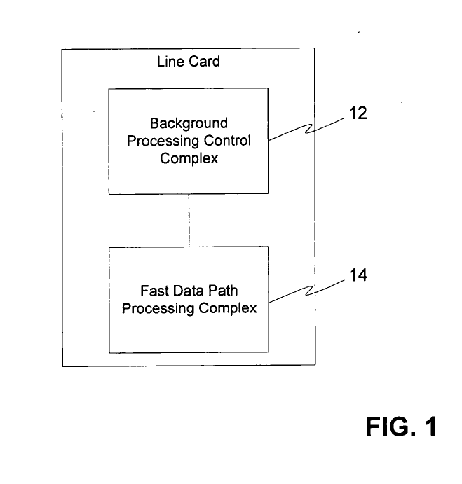

A line card can be schematically illustrated, as shown in FIG. 1, as a control complex 12 and a data path processing complex 14. This invention pertains to the situations when the data path processing complex of a line card fails. Such failure can be caused by the failure of all physical connections associated with a line card or the failure of the line card itself. Failure detection may be based on various methods known in the art. Failure detection makes the switch/router aware of the failed line card. There are two types of failures of interest: planned and unplanned. In a planned failure, the line-card is taken out of service by a network operator in a very controlled manner to perform software upgrades or other maintenance operations, or to decommission the card. In an unplanned failure, the line-card goes out of service due to a random event caused by factors such as power failure on the line-card, the failures of components on the line-card, software faults etc. The failures of interest in this case are those that affect the data path or data forwarding capabilities on a line-card.

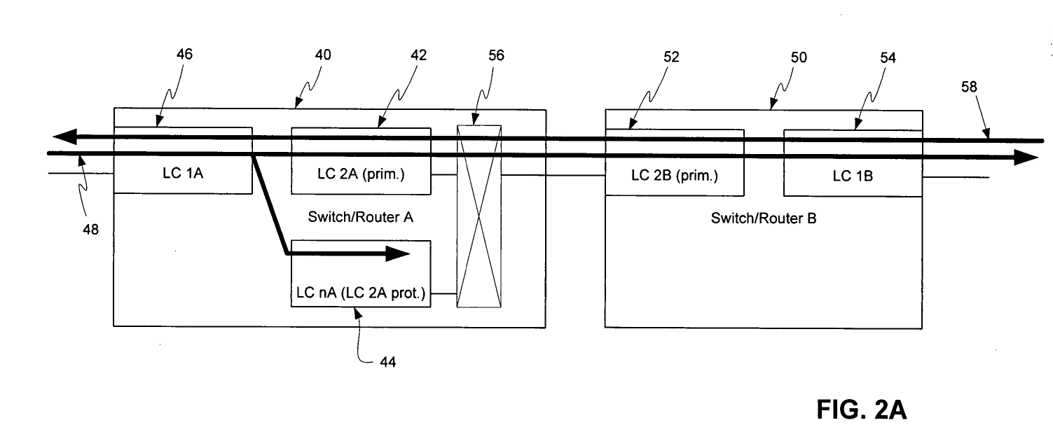

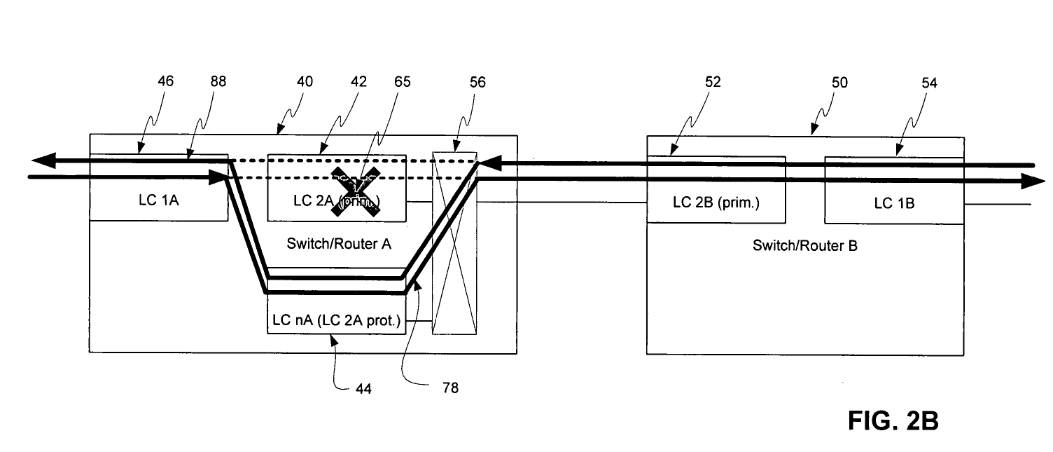

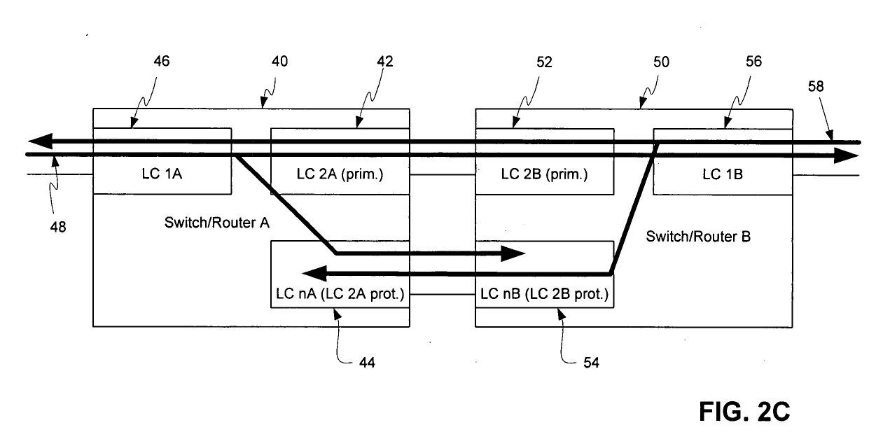

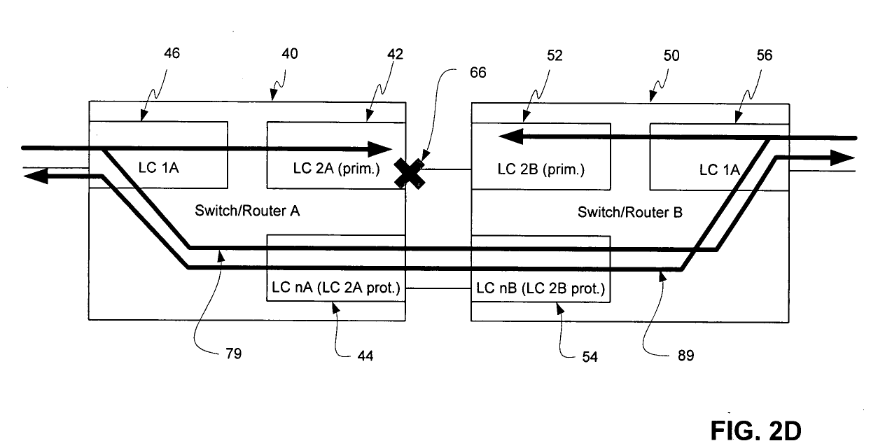

The invention provides two redundancy configurations: 1+1 redundancy and N:1 redundancy. In 1+1 redundancy, a line card to be protected is called a primary line card. Another line card, which must be exactly the same in every aspect (such as protocols, port rates, configurations, etc.) as its primary card is chosen to be its protection card. FIG. 2A illustrates the 1+1 redundancy configuration when one witch/router 40 (Switch/Router A) deploys line card redundancy while the neighboring switch/router 50 (Switch/Router B) connected to Switch/Router A has no line card redundancy. In this examples, Switch/Router A has a cross-connect 56 that connects each port to line cards. The function of the cross-connect enables the connection of the port to any line card, specifically it could be connected to a primary line card or a protection line card at a time requiring only one physical connection out of Switch/Router A (40) in this case. In FIG. 2A, in Switch/Router A (40), line card 2A (42) is a primary line card and line card nA (44) is the protection card of line card 2A (42). An active line card, is a line card which both receives and transmits data units. In FIG. 2A, before any failures, line card 2A (42) is an active line card. An inactive protection line card only receives the data units sent to it across the switch fabric and may not forward these data units. In Switch/Router B (50), line card 2B (52) and line card 1B (54) are configured as primary cards with no protection.

1+1 redundancy is explained concretely and without limitation by an example. In FIG. 2A, the data units of communication path 48 traverse Switch/Router A (40) and Switch/Router B (50). The return data units traverse the same path in the opposite direction 58. Line card 1A (46) receives data units which have to traverse Switch/Router B in order to get to their destination. The ingress component of line card 1A (46) determines that the data units have to be forwarded to line card 2A (42) and further to Switch/Router B based on information in the arriving data units (e.g., IP destination IP address in case of IP, VPI/VCI in case of ATM) and forwarding state (e.g., IP forwarding table in case of IP, circuit state in case of ATM). Then, line card 1A fragments the arriving data units into Fabric Data Units (FDUs) and puts in the header of every FDU control information that directs the fabric to forward each FDU to line card 2A (42). The fabric interface on Line card 1A (46), also determines that 1+1 redundancy is enabled for this card and that the protection card is line card nA (44). As a result, line card 1A (46) will forward the data unit to both line card 2A (42) and line card nA (44) across the switch fabric of Switch/Router A. Because line card 2A (42) is in the active state, it will forward the data units according to their routing information, as determined on the ingress, to Switch/Router B via the transmission link connecting it to card 2B on Switch/Router B. Then the data units will traverse the Switch/Router B (50) towards their final destination. The same path but in the opposite direction is traversed by the return data units (58). In FIG. 2B, a failure 65 occurs. The failure is within line card 2A (42) . Once the failure occurs, Switch/Router A (40), will receive alarms and will be aware that the communication through the line cards 2A (42) is no longer possible. Switch/Router A will cross connect the port connecting Switch/Router A (40) to line card 2B (52) on Switch/Router B (50) to the protection card nA (44) and will transition the protection card nA (44) to the active state, and the failed primary card to the inactive state. On system B (50), nothing changes. Because the ingress line card 1A (46) for the illustrated flows was already forwarding the data units to the now active protection card, as soon as it is active, the data units will traverse line card 1A (46), line card nA (44), line card 2B (52), and line card 1B (56) in one direction (78), and the same path in reverse order in the opposite direction (88). Every primary line card on the NE may be protected. In FIGS. 2A-B, Line Card 1A (46) may have 1+1 protection card (now shown). Both Line Card 1A (46) and this protection card would receive packets destined only for Line Card 1A (46), and in case it fails, the flow of data units would traverse the protection line card only. A variation on the scenario described in FIGS. 2A-B is shown in FIGS. 2C-D. FIG. 2C shows the cases where the primary line on Switch/Router A, line card 2A (42), is connected to line primary card 2B (52) on Switch/Router B via a transmission link and the protection line card nA (44) on Switch/Router A is connected via another transmission line to the protection card nB (54) on SwitchA/RouterB. This situation arises when both line card redundancy and line protection via Automatic Protection Switching (APS) are configured. (APS is a method of connecting and configuring the NE, so that if any single NE or its component fails, the connectivity between any two points in the network is still maintained.) In this case, the ports can still be connected via a cross-connect to line cards but this is not required. If 1+1 APS is used, the protection line card under 1+1 line card redundancy will forward data units received across the switching fabric on the transmission line but will not forward traffic received from the transmission line to the switching fabric when it is in the inactive protection mode. Upon line failure or card failure, as shown in the failure event 66 in FIG. 2D, the protection card will become the active card and will forward and receive data from the line. There are other scenarios that are known in the art to which the 1+1 redundancy scheme described here apply.

It is apparent that if 1+1 protection of every line card is desired, one additional card will be required for every primary card, in effect doubling the number of line cards required. Since half of the cards in this configuration will be idle at any given moment, the system will always be underutilized. To alleviate this doubling N:1 redundancy may be used.

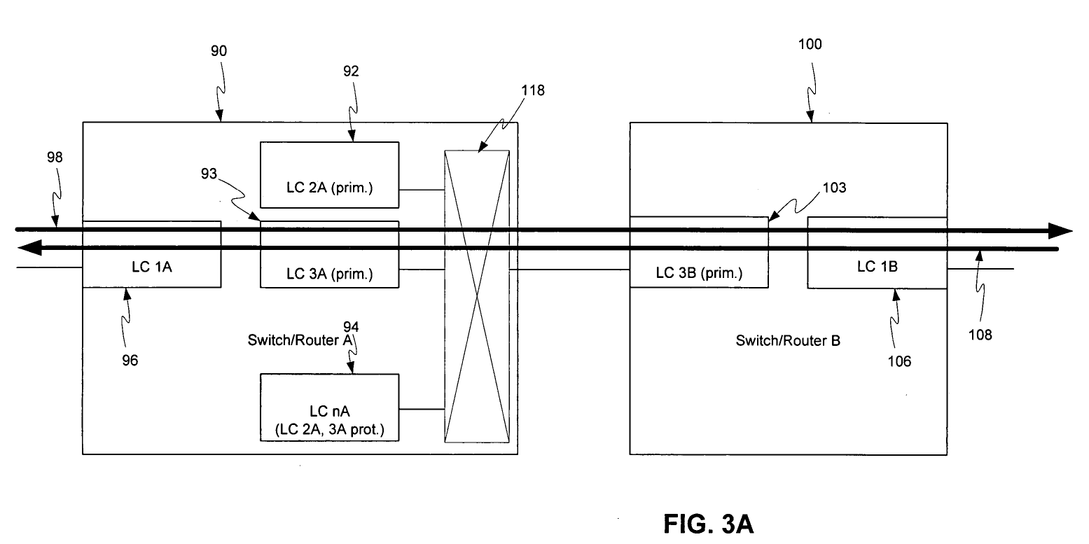

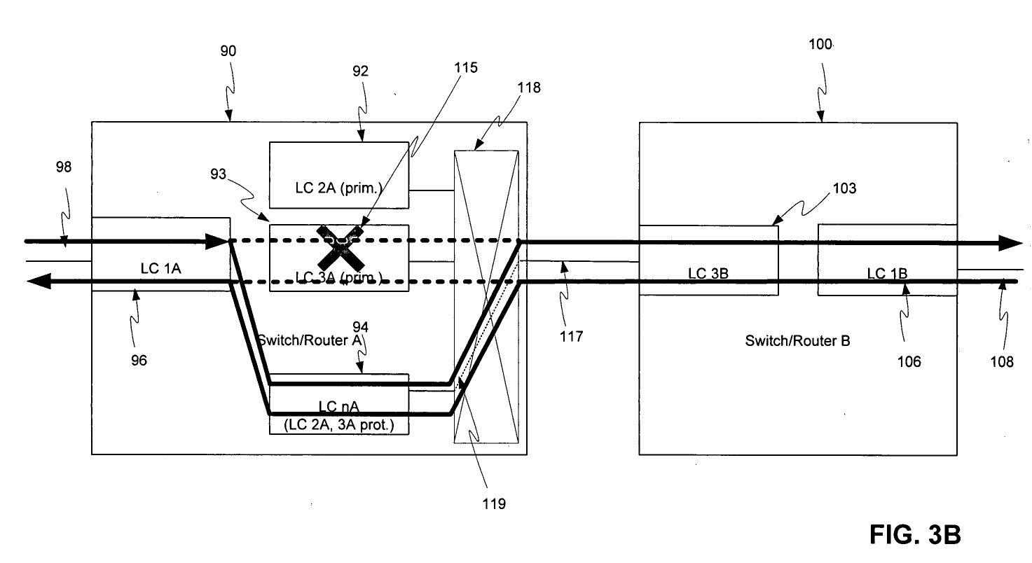

N:1 Redundancy is illustrated in FIGS. 3A-B. In FIG. 3A, a configuration of the NEs similar to FIGS. 2A-B is shown. In FIG. 3A, before any failures occur, data units traverse line card 1A (96), line card 3A (93) of the Switch/Router A (90) and then line card 3B (103) and line card 1B (106) of the Switch/Router B (100) in one direction 98, and the same line cards, but in the reverse order in the opposite direction 108. Line card nA (94) is now a protection card for line cards 2A (92) and 3A (93). Switch/Router B, as depicted here, has no line card protection. Unlike the case of 1+1 redundancy, an ingress line card does not send data units across the switch fabric to both the primary line card and the protection line card in N:1 redundancy. Since the protection line card protects more than one card, sending data units to the protection card as well as to the primary ones would result in the situation when a single protection card receives data units destined for more than one egress card. Consequently, only once the failure of one of the primary cards occurs and the switchover from primary to protection line card occurs, does the ingress line card start sending data units to the protection line card across the switch fabric.

In FIG. 3B, a failure of line card 2A (115) of Switch/Router A (90) occurs. In order for the forwarding of the data units to continue, the switch/router preferably provides the capability of connecting all the physical ports of a line card to the processing control complex of its protection card by means of automatic configuration. This is needed to guarantee that when the primary line card switches over to the protection line card, the network connectivity between the now active protection card and each neighboring NE is the same as that of the primary line card before the failure. That is the physical interfaces that were connected to the primary line card must be reconnected to the protection line card. This type of flexibility in connectivity between a line card and the physical interfaces can be achieved via a programmable cross-connect. The cross connect can be implemented by a sonnet cross-connect or a simple switch relay or other methods known in the art. In FIG. 3B, the interface (117) connecting the failed line card (93) to the Switch/Router B, must be reconnected to the protection line card 94 over the programmable cross-connect connection 118.

Once this cross-connect connection 119 is established, the flow of data units would have the following path: line card 1A (96), line card nA (94), the connection 119 of the programmable cross-connect, transmission link 117 to line card 3B on Switch/Router B, and then across the switch fabric of system B (100) to line card 1B (106). The flow in the opposite direction would traverse the same elements in the reverse direction.

N:1 redundancy is capable of supporting a single line card failure at one time. If a second line card, for example line card 2A (92), on system A (90) would fail, the data units which ordinarily traverse that line card would be lost until a routing protocol of a higher network layer would reconfigure the routing tables (in other NEs) so that data units could bypass this second failed card.

The present invention introduces a method that enables efficient redirection of the data units destined for a failed primary line card to its protection card. The efficiency reduces the number of operations and the time required to effectuate the redirection.

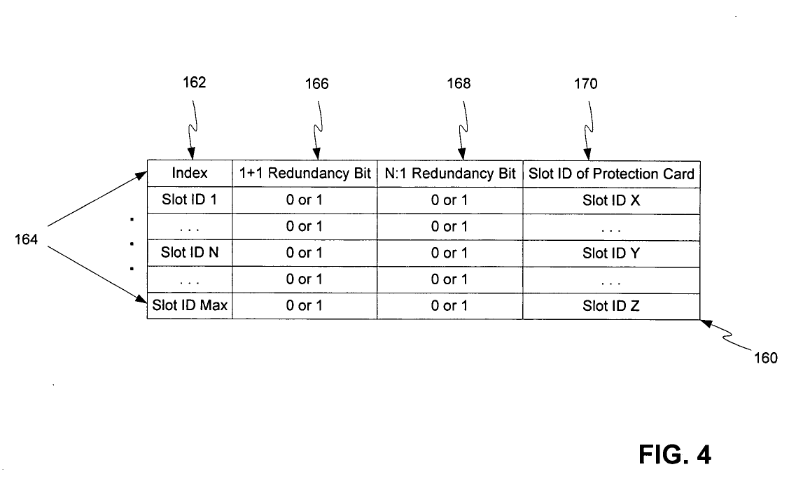

A preferred embodiment of the invention is based on a programmed table lookup that returns control information for steering data units from a primary line card to a protection line card that becomes active as a result of a failure. After receiving a data unit on an input port, it is determined to what line card in what slot the data unit is to be forwarded based on information in the data unit header (e.g., IP destination address in case of IP or VPI/VCI in case of ATM) and forwarding state information (e.g., IP forwarding table in case of IP). The data unit is chunked up into FDUs and a control is put in each FDU that, among other things, contains the destination slot for the FDU. Each FDU of the same data unit is destined to the same slot. Before the FDU is forwarded across the switch fabric, the redundancy table, shown in FIG. 4, residing in the memory of the line cards, is referenced based on the egress slot ID. The fields of this table provide the necessary information for the ingress component of the line card to recognize the type of redundancy enabled for any line card. If either type of redundancy is enabled for the primary line card the information on the type of redundancy and ID of the slot holding protection card could be accessed. FIG. 4 illustrates a preferred redundancy table. This preferred redundancy table is indexed by the slot ID (162) of the slot which holds the primary card. Every row (164) in the table contains a 1+1 redundancy indicator, such as bit 166, N:1 redundancy indicator, such as bit 168, and the slot ID of the slot holding the corresponding protection card (170).

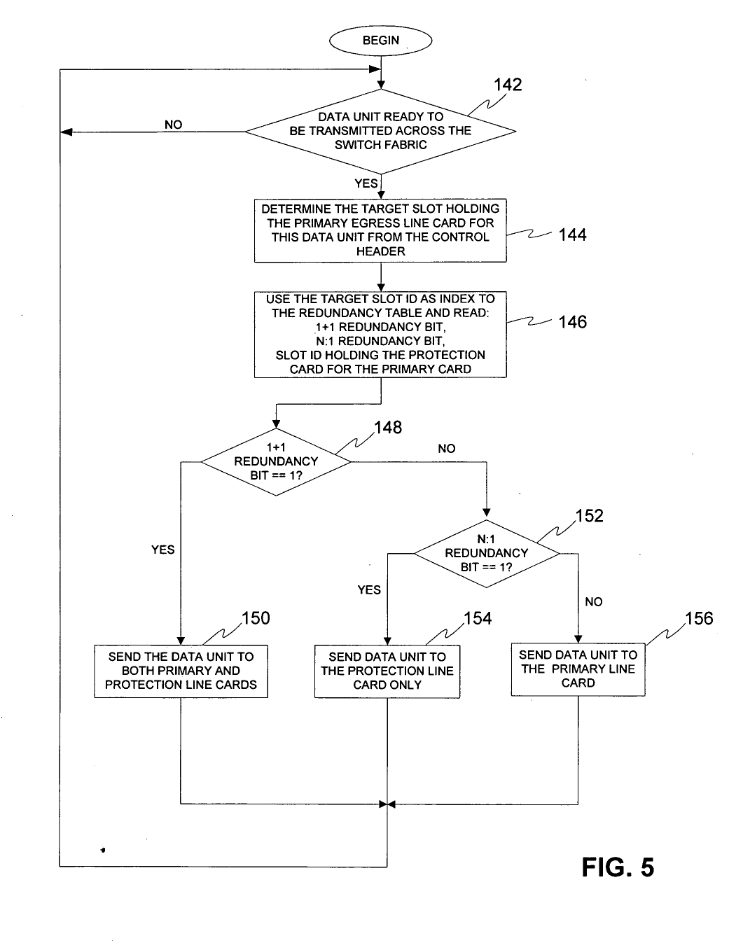

The steps shown in FIG. 5 are performed on a line card (for example by the ingress fabric interface device otherwise known as the mesh interface device in case of a mesh fabric). In step 142, a received data unit is ready for the transmission across the switch fabric. In step 144, a slot ID which holds the primary egress card for the given data unit is determined based on the FDU's control information. In step 146, the redundancy table is referenced with the slot ID (162 in FIG. 4) to read 1+1 redundancy bit (166 in FIG. 4), N:1 redundancy bit (168 in FIG. 4), and a slot ID of the slot which holds the protection line card (170 in FIG. 3). In step 148, the 1+1 redundancy bit is examined, and if it is determined that 1+1 redundancy is configured, the data unit is sent to the slots holding both primary and protection line cards, as shown in step 150. If in step 148, it is determined that 1+1 redundancy is not enabled, the N:1 redundancy bit is examined in step 152. If, in step 152, it is determined that N:1 redundancy bit is set, then the data unit is sent only to the slot holding the protection line card as shown in step 154. If, in step 152, it is determined that the N:1 redundancy is not enabled, then the data unit is only sent to the slot holding the primary line card, as shown in step 156.

This embodiment provides the functionality preferred for 1+1 redundancy, namely sending data units to both active and non-active line cards. When the alarms signaling the failure of a protected line card are received by the system, only a minimal time is required to switch the non-active protection line card to be active and vice versa. Thus, the redirection of the traffic takes just a few clock cycles and consequently just a few data units, if any, will be lost due to the failure.

1+1 redundancy requires sending two identical data units to two different line cards simultaneously. This resembles multicast functionality. In certain embodiments, the switch/router comprises a mesh switch fabric. The actual replicating of data units to the correct line cards is preferably done at the hardware level by a single command that indicates to the fabric hardware the slots to which the data unit should be sent. This is known as an “enable write” command and it enables the writing of the data unit to both mesh interfaces that connect to destination slots. In this manner transmitting the data unit to two line cards does not require increased memory bandwidth or scheduling cycles of the ingress line card. The replication method is described in greater details in the Multicast application. It should also be noted that the switchover of data flows from a primary card to a redundant card happens without the need for reprogramming the forwarding information.

In this embodiment, N:1 redundancy requires that upon a detected failure of a primary line card, N:1 redundancy bit in the appropriate row of the redundancy table be set from ‘0’ to ‘1’ in addition to changing the state of the protection line cards. Once the N:1 redundancy bit is set, data units will be forwarded to the protection line card as explained.

In certain embodiments of the invention, the protection groups may be configured to operate in a revertive or a non-revertive mode. In the revertive mode, when failed primary card is cured, it becomes active again and the protection card becomes inactive. For example in FIG. 2B, when failure 65 is removed, line card 2A (42) will assume active state and line card nA (44) will assume non-active state. This effectively will bring Switch/Router A (40) and Switch/Router B (50) to the state of FIG. 2A. In the non-revertive mode, even when the failure of primary card is cured, it will not become active and will remain inactive, unless its protection line card experiences a failure.

In the preferred embodiment, the FDUs are stored in one or more virtual output queues (VoQ) before they are transmitted on the fabric as described in the Scheduler Application. When a line-card asserts backpressure flow control on a particular VoQ on an ingress line card, dequeueing from that VoQ is ceased until backpressure is de-asserted. In the 1+1 case, the active line-card and the protection line-card can assert backpressure asynchronously to the same VoQ on an ingress line card. In that case, when either, or both, of these line cards, asserts backpressure on a VoQ, that VoQ is put in a state wherein the data units are not forwarded to either of those line cards. Both cards have to de-assert backpressure on a VoQ for data units to be sent out from that VoQ.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A system for switching or routing data units comprising a switch fabric interconnecting one or more slots uniquely identified by slot IDs and one or more line cards inserted into the slots, each line card being configured either as a primary or as a protection line card, the system further comprising:
a memory storing redundancy data, the redundancy data comprising for one or more primary line cards
a slot ID where the primary line card is inserted,
an indicator of whether or not 1+1 redundancy is configured the primary line card,
an indicator of whether or not N:1 redundancy is presently enabled for the primary line card,
a slot ID where the protection line card corresponding to the primary line card is inserted;
wherein at least one line card forwards each received data unit
to a destination primary line card, if neither 1+1 redundancy is configured nor N:1 redundancy is presently enabled for the slot into which the destination primary line card is inserted, wherein a destination primary line card for a data unit is a primary line card through which a network destination of that data unit is reachable, or
to the protection line card inserted into the protection slot identified by the redundancy data for the destination primary line card, if only N:1 redundancy is presently enabled for the slot into which the destination primary line card is inserted, or
to both the destination primary line card and to the protection line card inserted into the protection slot identified by the redundancy data for the destination primary line card, if only 1+1 redundancy is configured for the slot into which the destination primary line card is inserted.

2. The system of claim 1 wherein every line card comprises a memory storing the redundancy data.

3. The system of claim 2, wherein the redundancy data stored on a least one line card comprises a redundancy table with rows indexed by the IDs of the slots holding primary line cards, with a column for the 1+1 redundancy indicators, with a column for the N:1 redundancy indicators, and with a column for the IDs of the slots holding the protection line card.

4. The system of claim 1 wherein
the 1+1 redundancy indicator is set at all times for each line card protected with 1+1 redundancy, and
the N:1 redundancy indicator is set for each primary line card protected with N:1 redundancy only when that card has failed.

5. The system of claim 1, wherein the switch fabric comprises a mesh interconnection, and wherein, for at least one line card, when 1+1 redundancy is configured for a primary line card, the at least one line card forwards data units to both the primary line and protection line cards by a single software command to the switch fabric.

6. The system of claim 1 wherein, when either a primary line card configured for 1+1 redundancy or its corresponding protection line card assert backpressure to a particular ingress card with respect to a particular queue of data units, the forwarding of data units from that queue on that ingress card to both primary and protection line cards ceases, until the assertion of backpressure is dropped for that particular queue by both cards.

7. A method for switching or routing data units in a switch/router system comprising a switch fabric interconnecting one or more slots uniquely identified by slot IDs and one or more line cards inserted into the slots, each line card being configured either as a primary or as a protection line card, the method comprising forwarding received data units in dependence on redundancy data,
wherein the redundancy data comprises for each primary line card
(i) an indicator of whether or not 1+1 redundancy is configured for the primary line card,
(ii) an indicator of whether or not N:1 redundancy is presently enabled for the primary line card, and
(iii) a slot ID where the protection line card corresponding to the primary line card is inserted, and
wherein a received data unit is forwarded by at least one line card
to a destination primary line card if neither 1+1 redundancy is configured nor N:1 redundancy is presently enabled for that slot into which destination primary line card is inserted, wherein a destination primary line card for a data unit is a primary line card through which a network destination of that data unit is reachable, or
to the protection line card inserted in the slot identified by the redundancy data for the destination primary line card, if only N:1 redundancy is presently enabled for the slot where the destination primary line card is inserted, or
to both the destination primary line card and to its corresponding protection line card inserted in the slot identified by the redundancy data for the destination primary line card, only if 1+1 redundancy is configured for the destination primary line card.

8. The method of claim 7, wherein every line card comprises a memory with redundancy data for every slot holding a primary line card, and wherein forwarding further comprises referencing the redundancy data from the memory on the line card.

9. The method of claim 8 wherein the redundancy data is referenced from a table in the memory of each line card, and wherein the table comprises rows indexed by IDs of the slots holding the primary line cards, a column for the 1+1 redundancy indicators, a column for the N:1 redundancy indicators, and a column for the IDs of the slots holding the protection line card.

10. The method of claim 9 further comprising, in the redundancy data,
setting the slot IDs holding primary line cards, the IDs of the slot holding the protection line card, and the 1+1 redundancy indicators for line cards protected with 1+1 redundancy only when the switch/router is initialized and/or when the switch/router configuration is changed, and
setting the N:1 redundancy indicators for a primary line card that is protected with N:1 redundancy only when that primary line card fails.

11. The method of claim 7, wherein the switch fabric comprises a mesh interconnection, and wherein, for at least one line card, when 1+1 redundancy is configured for a primary line card, the at least one card forwards data units to both the primary line and protection line cards by a single software command to the switch fabric.

12. The method of claim 7, wherein, when either a primary line card that is configured for 1+1 redundancy or its corresponding protection line card assert backpressure on an ingress card with respect to a given virtual output queue of data units, the forwarding of data units from that virtual output queue on the ingress card to both primary and protection line cards ceases, until the assertion of backpressure is dropped for that virtual output queue by both cards.

13. The method of claim 12 further comprising, upon the detection of a failure of a primary card, the steps of:
setting the N:1 indicator, if N:1 redundancy is configured for the slot holding the failed card;
changing the state of the protection line card, corresponding to the failed primary line card, to active;
changing the state of the failed line card to inactive.

14. A system for switching or routing data units comprising a switch fabric interconnecting one or more slots uniquely identified by slot IDs and one or more line cards inserted into the slots, each line card being configured either as a primary or as a protection line card, the system further comprising:
a memory storing redundancy data, the redundancy data comprising slot IDs of primary line cards and their corresponding protection line cards and indicators of the type of redundancy configured for the primary line cards, and
at least one line card that forwards received data units to a destination line card and/or to its corresponding protection line card in dependence on the redundancy indicators, wherein a destination primary line card for a data unit is a primary line card through which a network destination of that data unit is reachable.

15. The system of claim 14 wherein every line card comprises a memory storing, for every slot holding a primary line card, redundancy data comprising:
the slot ID of the slot holding the protection line card for that primary line card;
an indicator of whether 1+1 redundancy is configured for that primary line card; and
an indicator of whether N:1 redundancy is presently enabled for that primary line card.

16. The system of claim 14 wherein the said line card forwards received data units
to a destination primary line card, if neither 1+1 redundancy is configured nor N:1 redundancy is presently enabled for that slot into which the destination primary line card is inserted, or
to the protection line card inserted into the protection slot identified by the redundancy data for the destination primary line card, if only N:1 redundancy is presently enabled for the slot into which the destination primary line card is inserted, or
to both the destination primary line card and to the protection line card inserted into the protection slot identified by the redundancy data for the destination primary line card, if only 1+1 redundancy is configured for the slot into which the destination primary line card.
